(19) United States
(12) Patent Application Publication
(10) Pub. No.: US 2006/0103062 A1
(43) Pub. Date: May 18, 2006

(54) Fluid damper & pulley kit

(76) Inventor: Shu Woody Hwang, Los Angeles, CA (US)

Correspondence Address: Shu Woody Hwang, 345 Cloverleaf Drive, #C, Baldwin Park, CA, 91706, US

(21) Appl. No.: 10/893,701

(22) Filed: Sep. 23, 2004

(51) Int. Cl. B60G 13/00; F16F 11/00

(52) U.S. Cl. 267/217

(57) ABSTRACT

An oversized Inside Diameter of damper steel hub will prevent the damper outer housing to disintegrate and fly out form the hub which is mounted on the crankshaft snort as a solid piece The invention of this explosion proof steel harmonic damper is designed to have a larger outside diameter of damper steel hub mounted with a smaller inside diameter of steel outer housing with sulfated elastic rubber inserted into an “S” shape gap between hub and housing under heated and pressed process. In an event, if the elastic sulfated rubber has lost binding character due to constantly expose to high heat of high engine RPM, or by any unexpected external force to destroy the integrity of this steel harmonic damper unit, the smaller steel outer housing has no access to separate and blow out from the hub to cause further damage by the blown out steel housing. This invention is a true Explosion Proof Steel Harmonic Damper.

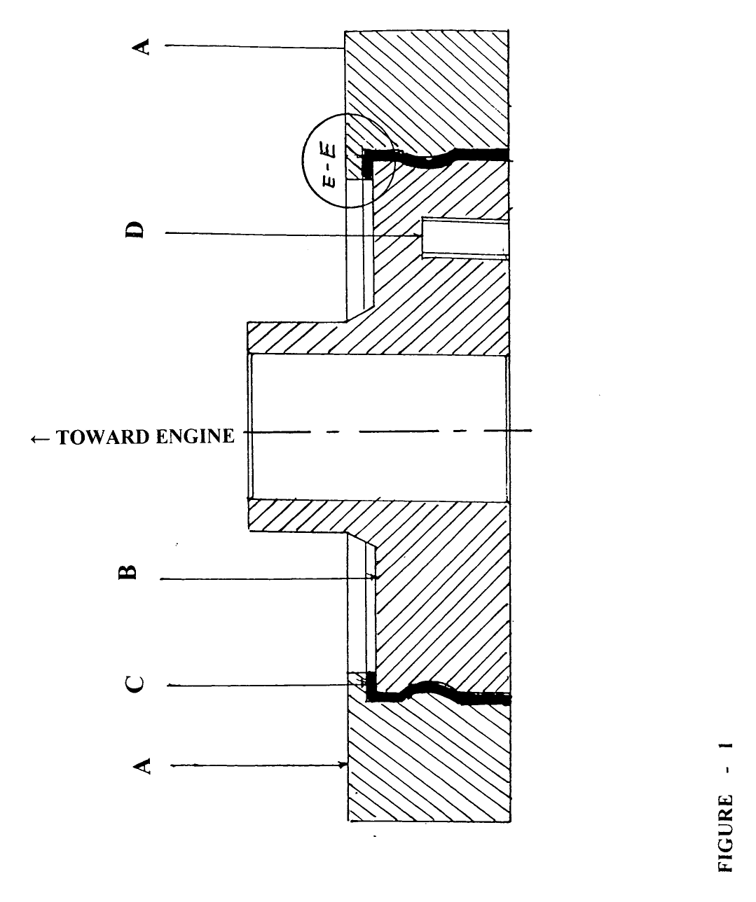

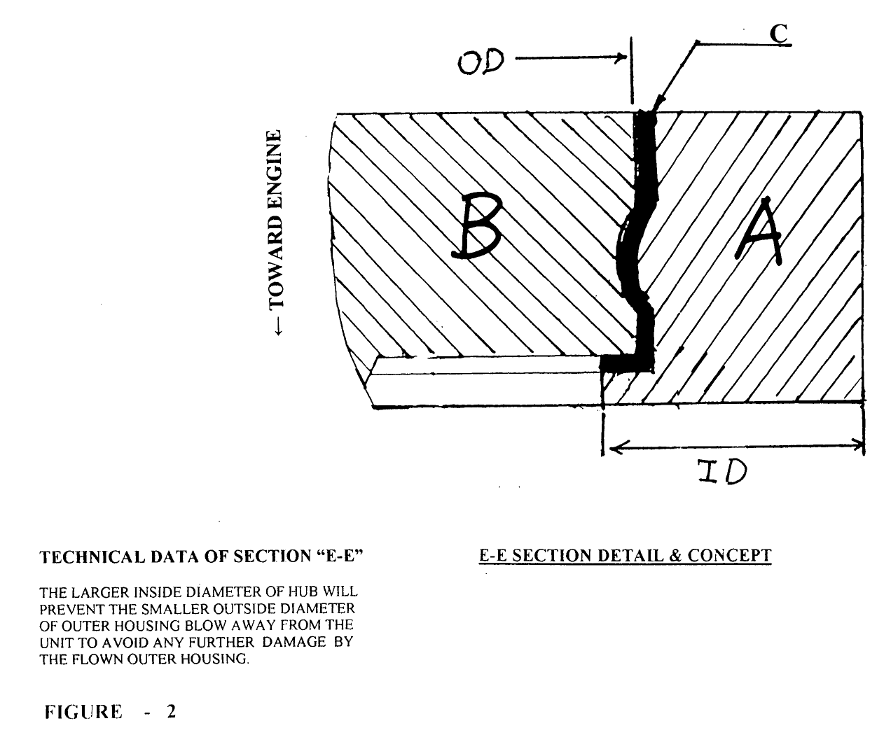

At present market, there are elastic style steel harmonic dampers. All these dampers are manufactured from forging steel and insert with elastic rubber. Although, these dampers has been tested to 12,000 RPM for explosion proof. But, these damper has been exposed under high heat from high engine RPM for a certain period, the inserted elastic rubber might loss elastic and binding characters. Also, incase of any external force to damage the integrity of this damper, the outer housing of damper might separate and fly out from the hub and cause serious damage by the outer housing.

The undersigned invented a smaller inside diameter of outer housing compare to the outside diameter of hub. The larger outside diameter of hub will prevent the outer housing to separate and fly out from the unit under any circumstance.

In today's market the explosion proof elastic rubber steel harmonic damper is available in certain version. These explosion proof elastic rubber harmonic dampers are manufactured from forging steel and inserted with sulfated rubber. Which has been tested 12,000 RPM for explosion proof. However, the inserted sulfated rubber in between inner hub and outer housing is always exposed to high heat from high engine rpm and cold weather condition. For a certain period, the inserted sulfated rubber may loss elastic and binding characters from open atmosphere. Furthermore, the integrity character of damper may damaged from any unexpected external force during engine normal operation, in such case, the outer ring will be separated from the damper and flown out from the hub and cause serious consequently damage.

1. What I claim of my invention is from design change, the new design has a smaller inside diameter of steel outer housing to install together with a larger outside diameter of steel hub. The larger outside diameter of steel hub will absolutely prevent the steel outer housing move out from the damper.
In any circumstance, if the sulfated rubber lost elastic character or the steel outer housing is separated from the damper by any incidence. The outer housing has no accessing to escape from the hub.
